(19) United States
(12) Patent Application Publication
(10) Pub. No.: US 2005/0269920 A1
(43) Pub. Date: Dec. 8, 2005

(54) Combination table lamp/lockable DC/DVD holder/remote control holder

(76) Inventor: Richard C. Sprague, Jefferson, LA (US)

Correspondence Address: Richard C. Sprague, 610 Lurline Dr., Jefferson, LA, 70121, US

(21) Appl. No.: 10/859,709

(22) Filed: Jun. 3, 2004

(51) Int. Cl. E06B 1/00

(52) U.S. Cl. 312/321.5

(57) ABSTRACT

My invention, a Combination Table Lamp/Lockable CD/DVD Holder/Remote Control Holder, makes enjoying home entertainment more convenient and easier. With my invention a person no longer will need to search around for a DVD movie to watch or a CD to listen to and the search for the misplaced remote control units can be a thing of the past. With my invention, all these things are kept in one easy to find place. The lamp next to a person's sitting place in the home entertainment area can store all these items. Additionally, if a person likes to watch movies or listen to CD's in the dark, the lamp makes it easy when the DVD being watched or the CD being listed to is over and a new one needs to be played to read the next easy to get DVD or CD without leaving the person's seat. Another feature o my invention is that the DVD and CD section has a door that can be closed and locked so if there are children in the house and the adults have DVD's or CD's that are not suitable for the children, they can be locked up and the children can't get to them or even see them.

### CROSS REFERENCE TO RELATED APPLICATIONS

“Not Applicable”

### STATEMENT REGARDING FEDERALLY SPONSERED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

In the past if one wanted to enjoy home entertainment such as watching a DVD movie or listening to a CD, one would have to stand up and rummage around to find the wanted DVD or CD, which also usually meant having to walk to a wall switch to turn on a light and search the room for the wanted DVD or CD as well as try to find the remote control unit for the desired entertainment appliance. Remotes for DVD players, CD players, VCR units and televisions often get misplaced. Another problem that faces people with children is that certain DVD's and CD's are not suitable for their children but the children have been able to get the questionable DVD's or CD's and before the parents know it, they are using them. My invention, “The Combination Table Lamp/Lockable CD/DVD Holder/Remote Control Holder” solves these problems.

### BRIEF SUMMARY OF THE INVENTION

In the past, if a person wanted to watch a DVD or Play a CD, that person would generally have to get up from his or her seat and rummage around to find the wanted DVD or CD. That person would also generally have to either turn on a light switch or a lamp that would usually be a distance from the CD or DVD. In addition, there are many times that a person would not be able to easily locate their remote control unit to use whatever entertainment appliance that was wanted at the time. My invention solves these problems. With my combination table lamp lockable DVD, CD holder, remote control holder, all these products can be kept within arms length of a person's favorite sitting place. A person will be able to turn on a lamp, find the DVD or CD that he or she wants and easily find the remote control for the wanted entertainment appliance all without leaving the comfort of the place the person enjoys sitting while enjoying home entertainment

If a person likes to watch movies or listen to music in the dark and is going to watch more than one movie or listen to more than one CD, my invention makes it easy to turn a lamp off and on between selections and find the next DVD or CD that a person would want to use again without having to leave the comfort of the person's sitting place. My invention also can hold and store upwards of four (4) remote control units. A person will never again have to search all over to locate misplaced remotes for their television, DVD player, CD player or VCR unit.

An added feature of my invention is that the DVD and CD section can be locked so if a person or persons have DVD's and CD's that are not suitable for younger audiences, said DVD's and CD's can be kept out of the younger audiences reach and sight.

### BRIEF DESCRIPTION OF THE SEVERAL VIEWS OF THE DRAWINGS

FIG. 1

Front View with open door.

FIG. 2

Side view with remote control holder.

FIG. 3

Side view of base—hinged side.

FIG. 4

Back view to show location of electrical plug and location of extension for light bulb apparatus.

FIG. 5

Extension for light bulb apparatus with shade (see through) to show location of key for lock.

FIG. 6

Front view—Door

FIG. 7

Inside back panel to show groove for electrical wire.

FIG. 8

Inside top panel to show recessed hole where tube that electrical wire is run through.

FIG. 9

Light socket hoop-up.

FIG. 10

View from top of top plate of lamp.

FIG. 11

Extension for light bulb apparatus.

### DETAILED DESCRIPTION OF THE INVENTION

My invention is “The Combination Table Lamp/Lockable CD/DVD Holder/Remote Control Holder”. The base is made to hold a minimum of eight (8) CD's, six (6) DVD's and upwards of four (4) remote control units. This lamp also is made with a door in front and a lock to keep DVD's and CD's safe and out of children's reach. This lamp can be made from a variety of solid materials including but not limited to wood, metal, glass, plastic, etc. As previously mentioned, it has a lockable door and the inside has two compartments. The top compartment is the right height for CD's and the bottom is the right height for DVD's. The shelf that separates the compartments is just enough shorter then the depth of the base to make it easy to pull the desired DVD or CD from the lamp. There is a side holder that is the right size to hold a minimum of two remotes. The top is large enough to hold at least two more remotes. The light itself is extended high enough so that no heat can reach any of the items being stored on top or inside the lamp. A detailed description of the drawings and more detailed information follows to further explain and show how this lamp is made and used.

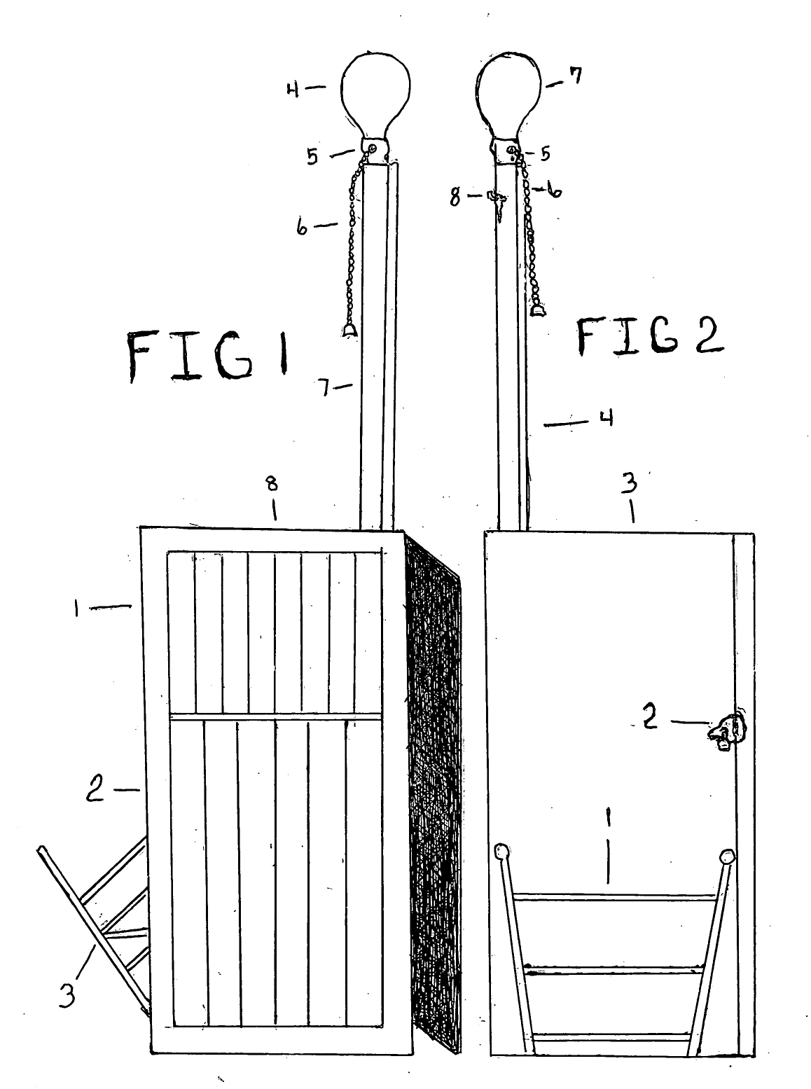

FIG. 1 is a front view of the lamp with the door (the shaded area) open. #1 is the top shelf that holds a minimum of eight (8) CD's. #2 is the bottom shelf that holds a minimum of six (6) DVD's. #3 is the holder for a least two remotes. #4 through #7 show the light extension unit. #4 light bulb. #5 light socket. #6 pull chain to turn light on/off. #7 Extension to keep the heat of the light away from the items on and in the lamp base. #8 is the top of the lamp showing room for two remote controls.

FIG. 2 is the side view with the remote control holder that can be made on either the left or right side of the lamp base depending on where a person would want to place the lamp. In the case of having two lamps, one can be placed on either side of a sofa in which case each lamp would need the holder on opposite sides. #1 remote control holder. #2 padlock and hasp to lock the door (locks may vary between padlock and door lock). # 3 the top of base. #4 light extension. #5 light socket. #6 pull chain. #7 light bulb. #8 key holder and key.

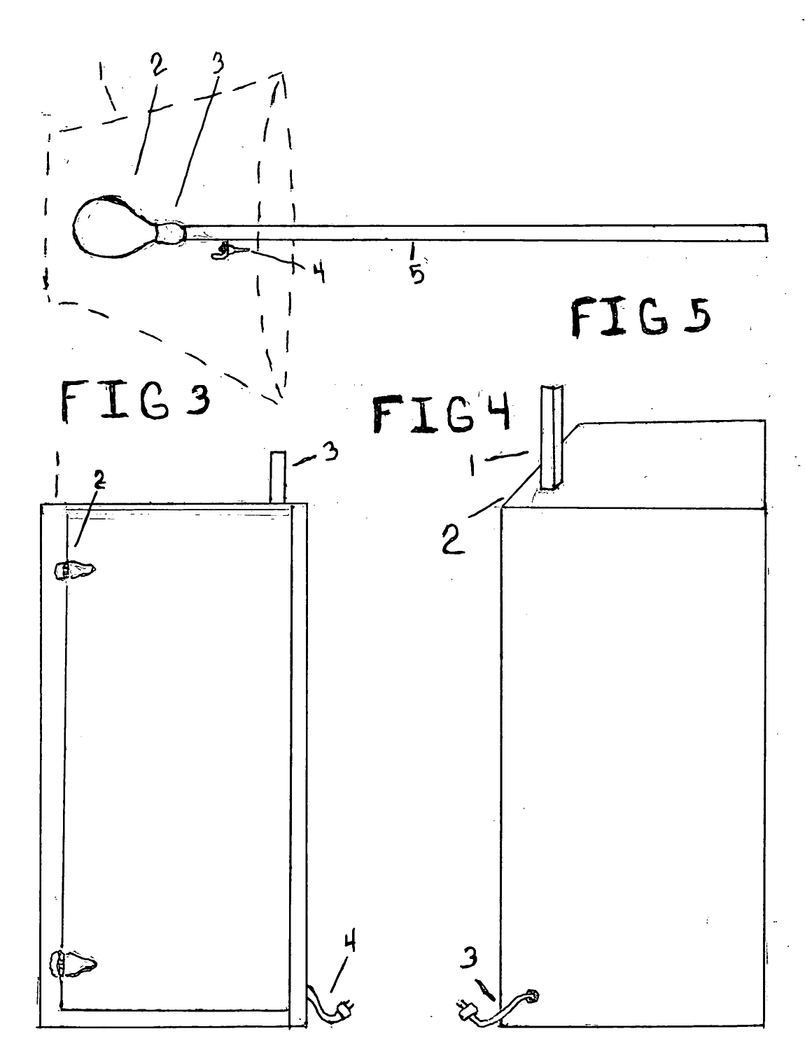

FIG. 3 shows the hinged side of the lamp, which may be either side depending on placement of the remote control holder (FIG. 1 #3 and FIG. 2 #1). #1 is side of the door. # 2 hinges. #3 partial light extension. #4 electrical wire and plug.

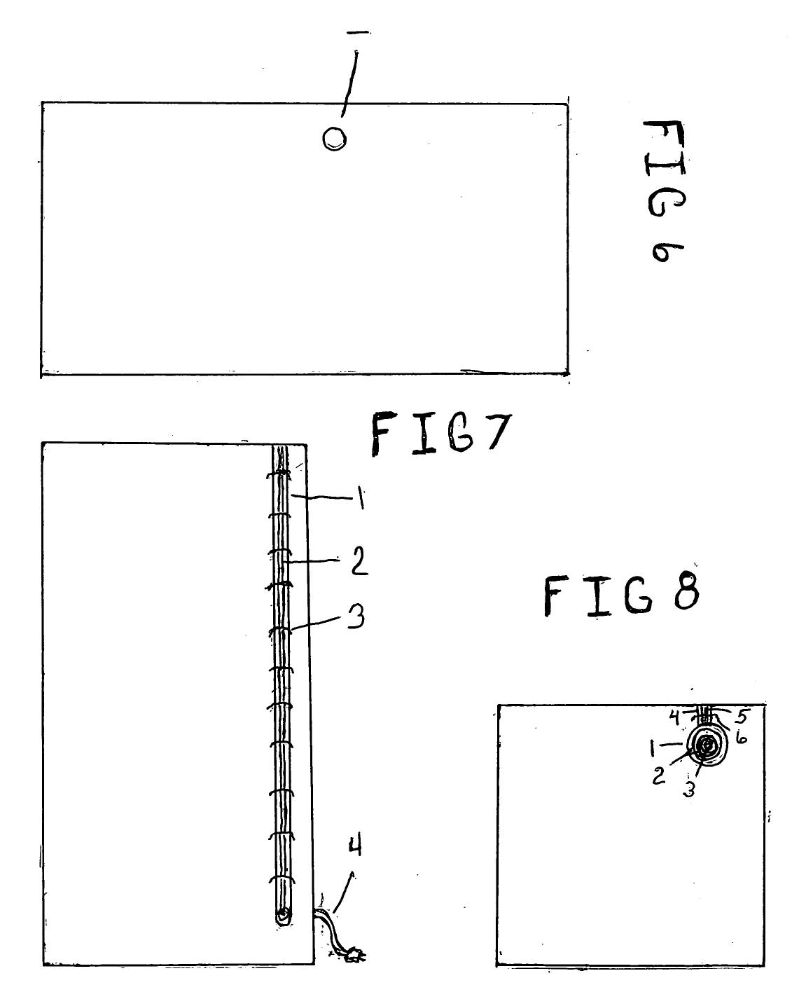

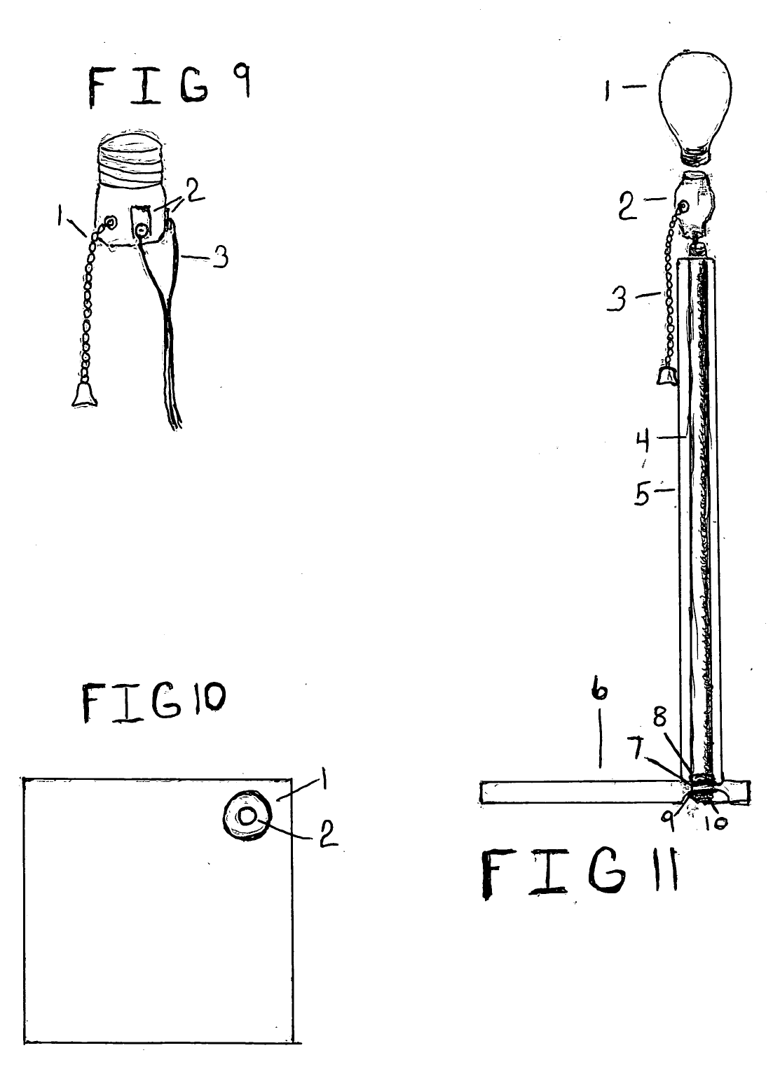

FIG. 4 shows the back of the lamp. #1 light extension. #2 top of base. (#1 and #2 are to show the placement of the light extension.) #3 shows the location of the hole for the plug wire to run through the back of base.

FIG. 5 shows the light extension with a shade (drawn see through) to show how the shade hides the key holder and key. #1 shade. #2 light bulb. #3 light bulb socket. #4 key holder with key. #5 light extension.

FIG. 6 is the door. #1 shows the placement of the doorknob or handle.

FIG. 7 shows the inside back panel which is grooved to run the wire for the light through then staples are used to hold the wire (a thin panel may be used in place of staples). #1 groove for wire. #2 wire. #3 staples. #4 wire and plug on the outside.

FIG. 8 shows the inside of the top panel. #1 hole for the threaded tube to run wire through to the light. #2 nut and washer to hold threaded tube. #3 threaded tube end (note: hole is recessed so that nut washer and threaded tube end all fit inside the panel. The tube end is even with the bottom of the surface of the inside top. #4 small groove for the wire that matches up with the groove in the back panel, (FIG. 7 #1). #5 wire. #6 staples.

FIG. 9 shows inside of light socket. #1 pull chain. #2 connectors for wire. #3 wire spliced and connected to connectors.

FIG. 10 shows view from top of top plate. #1 recessed hole for countersinking washer and nut on bottom threaded end of tube that wire runs through. #2 hole for tube to go through.

FIG. 11 shows light assembly (top). #1 light bulb. #2 light socket #3 pull chain. #4 tube to run wire through (threaded on both ends). #5 decorative casing (extension for light). #6 top plate with cutaways to show counter sinking. #7 top washer. #8 top nut #9 bottom washer. #10 bottom nut.

Notes: Depending on material used, the lamps can be held together with nails and glue, screws, rivets or can be welded. The inside measurements for the lamp to hold eight (8) CD's and six (6) DVD's are as follows: Width—3 3/4″, Total Height—13″, Depth 5—¾″. The middle separator (top shelf) should be installed so that the bottom of the separator is 7 3/4″ from the bottom of the inside of the lamp. The separator should be ⅜″ to ½″ thick and the depth measurement should be at least ½″ shorter than the rest of the lamp base depth. The outside measurements can vary according to the type of material used. The remote control holder may vary in size but must be set at a sufficient angle so as to securely hold the controls. Height of the light extension including light bulb socket must be a minimum of 14″. At this height a light bulb up to 100-watts may be used without heat from the light bulb affecting anything on top of or inside of the lamp base. Though, I recommend no higher than a 75-watt bulb be used with the lamp. The outside measurements for aesthetic purposes and to accommodate the size of most standard end tables or other such tables that are usually found in the home entertainment area of most homes should be as follows: Base—Width—5 1/2″, Height—14 1/2″, Depth—7 1/2 (including door). Remote Control Holder should be set at an angle so that the top of the holder extends no more than 3″ to 4″ from the side of the lamp base. The best placement for the key hook is 1″ from the top of the light extension. At this size my Lamp/CD/DVD/Remote Control Holder will fit on most nightstands.

1. A Combination Table Lamp/Lockable CD/DVD Holder/Remote Control Holder that provides area illumination as well as a place to conveniently and safely store easily misplaced entertainment items, CD's, DVD's, and remote control units for entertainment appliances such as; televisions, CD players, DVD players and VCR units.

2. My invention as stated in claim 1 can be used to conveniently and safely store CD's (a minimum of eight (8)), DVD's (a minimum of six (6)), and remote control units for a variety of entertainment appliances. The CD's and DVD's can be safely kept, as the storage area can be easily locked.

3. My invention as stated in claim 1 can be used to hold and keep in an easy to find area often misplaced remote control units (minimum of four (4)) for entertainment appliances such as; television, CD players, DVD players and VCR units.
